(19) United States
(12) Patent Application Publication
(10) Pub. No.: US 2009/0009696 A1
(43) Pub. Date: Jan. 8, 2009

(54) POLARIZER AND METHOD OF MANUFACTURING THE SAME

(75) Inventors: Myeong-Ha KYE, Seoul (KR); Jae-Jin LYU, Yongin-si (KR); Seung-Ju LEE, Gwangmyeong-si (KR); Yun JANG, Suwon-si (KR); Sung-Min KANG, Seoul (KR); Seung-Hee LEE, Seoul (KR); Hee-Wook DO, Cheonan-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/926,964

(22) Filed: Oct. 29, 2007

(30) Foreign Application Priority Data
Jul. 2, 2007 (KR) 2007-66141

(51) Int. Cl. G02B 5/30; B29D 7/01; G02F 1/1335

(52) U.S. Cl. 349/96; 264/1.34; 359/500; 428/1.31

(57) ABSTRACT

A polarizer includes a first, second and third support layers, a first polarizing element disposed between the first support layer and the second support layer and the second polarizing element disposed between the second support layer and the third support layer. During the process of manufacturing the polarizer, the polarizer is stretched in the direction of length until the width of the polarizer after stretching is not less than half of the width of the polarizer before stretching.

### CROSS-REFERENCE TO RELATED APPLICATION

This application claims priority to Korean Patent Application No. 2007-66141, filed on Jul. 2, 2007 and all the benefits accruing therefrom under 35 U.S.C. §119, and the disclosure of which is herein incorporated by reference.

### BACKGROUND OF THE INVENTION

1. Technical Field

The present invention relates to a polarizer used in a liquid-crystal display device, and a method of manufacturing the polarizer; and particularly to a polarizer which is able to cover a large sized liquid crystal display panel.

2. Discussion of the Related Art

A liquid crystal display (LCD) device displays an image by using a liquid crystal layer. Since the LCD device may be thinner, lighter, and uses a low driving voltage compared to other display devices, the LCD device has gained wide acceptance. A Conventional LCD device includes a liquid crystal panel having color filters to display color and a light supplying unit having a light source such as CCFL (Cold Cathode Fluorescent Lamp) and LED (Light Emitting Diode) to provide light to the liquid crystal panel. Furthermore, a pair of polarizer is included. One of the pair of polarizer is disposed between the light supply unit and the liquid crystal panel. The other of the pair of polarizer is disposed on the top of the liquid crystal panel.

A polarizer generally constitutes a polarizing element made of a polyvinyl alcohol (PVA) film containing iodine or dichromatic dye adsorbed thereto; and a pair of support layers which are made of a triacetyl cellulose (TAC) film or the like and disposed on opposite, front and rear surfaces of the polarizing element so that the polarizing element is held between the pair of support layers, because of its relatively inexpensive cost and excellent polarization performance.

However, the conventional polarizer can not cover a large liquid crystal display (over 60 inches) with one sheet of polarizer because the width of the polarizer is generally reduced to 1475 mm from 3300 mm after stretching process for having appropriate polarizing characteristic. If a polarizer is not enough to stretch to make a bigger polarizer, polarizing characteristic will be reduced. That is to say, size of polarizer and polarizing characteristic are trade-off relationship each other.

### SUMMARY OF THE INVENTION

A polarizer according to an exemplary embodiment of the present invention includes a first, second and third support layers and a first, second polarizing elements. The first polarizing element is disposed between the first support layer and the second support layer and the second polarizing element is disposed between the second support layer and the third support layer. Alternatively, the first polarizing element and the second polarizing element are directly contacted each other without a support layer between them. Both the first polarizing element and the second polarizing element have 90% polarizing rate or less. At least one of the polarizing elements is a polyvinyl alcohol layer and at least one of the support layers is a triacetyl cellulose film.

According to another exemplary of the present invention, a display device includes a light source to generate light, a liquid crystal panel disposed in the path of the light source and including a pair of substrates, an electrode formed on at least one of the substrates and a liquid crystal layer disposed between the pair of substrates, and a first polarizer disposed between the light source and the liquid crystal panel, and a second polarizer disposed on the top of the liquid crystal panel. At least one of the first and second polarizers includes a first, second and third support layers and a first, second polarizing elements. The first polarizing element is disposed between the first support layer and the second support layer and a second polarizing element is disposed between the second support layer and the third support layer. Alternatively, the first polarizing element and the second polarizing element are directly contacted each other without a support layer between them.

For manufacturing a polarizer according to an exemplary embodiment of the present invention, it is required that a preparing step prepares an non-stretched polarizer having width and length, which comprises at least two support layers and at least two polarizing elements, and a stretching step stretches the polarizer in the direction of length until the width of the polarizer after stretching is not less than half of the width of the polarizer before stretching.

In an exemplary embodiment of the present invention, the width of the polarizer before stretching is about 3300 mm and the width of the polarizer after stretching is not less than 1870 mm. Furthermore, the diagonal length of the polarizer after stretching is not less than 60 inches.

### BRIEF DESCRIPTION OF THE DRAWINGS

Exemplary embodiments of the present invention can be understood in more detail from the following descriptions taken in conjunction with the accompanying drawings, in which:

FIG. 1 is a conventional structure of a Liquid Crystal Display;

FIG. 2 is a conventional structure of a polarizer;

FIG. 3 is a diagram showing stretching process while a polarizer is being manufactured;

FIG. 4 is a diagram showing joined polarizers which cover a large display panel;

FIG. 5 (a) is a structure of a Polarizer described in exemplary embodiments of present invention;

FIG. 5 (b) is an another structure of a Polarizer described in exemplary embodiments of present invention;

FIG. 6 is a graph showing the relationship between polarizing rate and stretching rate;

FIG. 7 is a graph showing the relationship between polarizing rate and transparent rate of light when a conventional polarizer is used; and

FIG. 8 is a graph showing the relationship between polarizing rate and transparent rate of light when the polarizer of present invention is used;

### DESCRIPTION OF EXEMPLARY EMBODIMENTS

Exemplary embodiments of the present invention are described more fully hereinafter with reference to the accompanying drawings, in which exemplary embodiments of the invention are shown.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

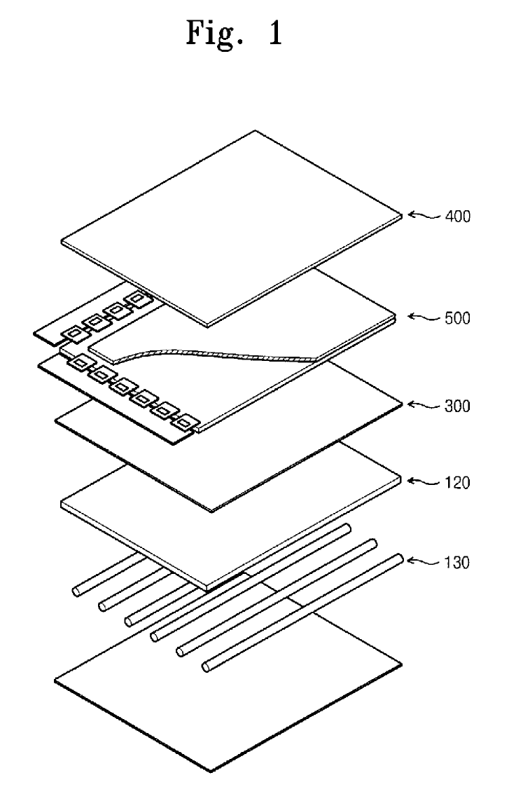

FIG. 1 illustrates a conventional structure of a Liquid Crystal Display Device which includes a light supplying unit, a liquid crystal panel 500 and a driving circuit.

Since the liquid crystal panel 500 is not a self-emissive device, a light source 130 needs to be supplied to illuminate light through the liquid crystal panel 500 to display an image. The light supplying unit includes a light source 130 and a light guiding element 120 including a light enhancing element such as a prism film and/or a diffuser film. The liquid crystal panel 500 includes a pair of polarizers 300, 400, a pair of substrates facing each other, electrodes formed on the substrates and liquid crystal molecules filled in between the pair of substrates. The pair of polarizer 300, 400 polarizes the light coming from the light supplying unit.

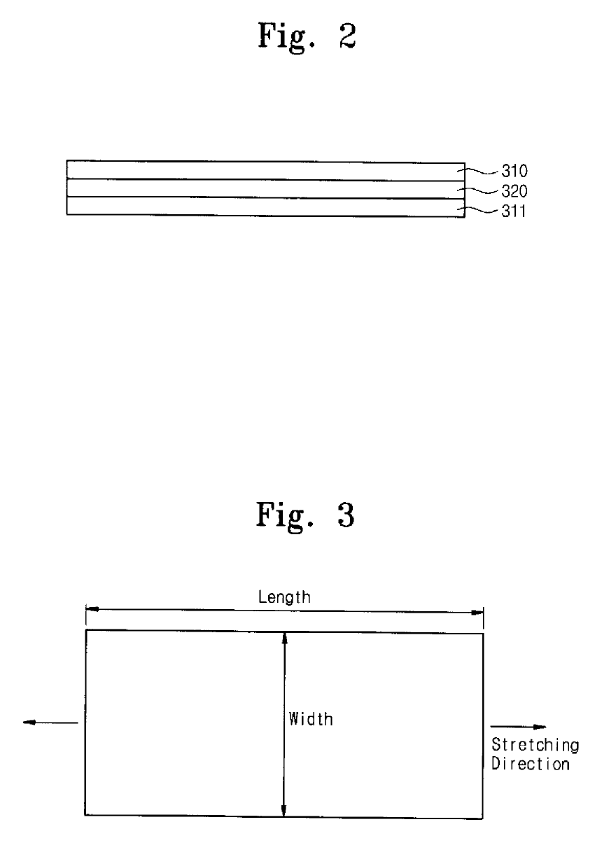

FIG. 2 shows a conventional structure of polarizer. A conventional polarizer consists of a polarizing element 320 made of a polyvinyl alcohol (PVA) film containing iodine or dichromatic dye adsorbed thereto; and a pair of support layers 310, 311 which are made of a triacetyl cellulose (TAC) film or the like and disposed on opposite, front and rear surfaces of the polarizing element 320 so that the polarizing element 320 is held between the pair of support layers 310, 311. Shown in FIG. 3, when a polarizer is being manufactured, TAC/PVA/TAC structured polarizer is stretched in the direction of length. While the non-stretched polarizer is stretched in the direction of length, the width of the non-stretched polarizer is reduced. The stretching process is necessary process for a polarizer having polarizing characteristic. In order to get appropriate polarizing rate of the polarizer, the non-stretched polarizer is stretched up to 5.8 times.

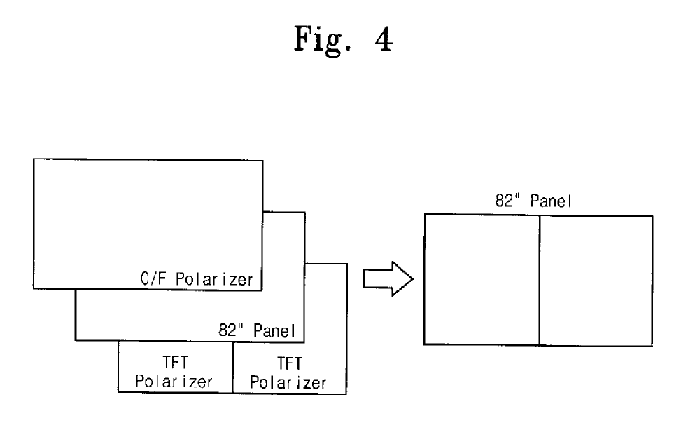

However, due to the need of a large display device for a Digital Information Display (“DID”), Liquid Crystal Display (“LCD”) which is over 60 inches is required. But, the maximum size of commercially available polarizer with appropriate polarizing rate is less than 60 inches. Thus, to make a large LCD which is over 60 inches is to require joined polarizers. For example, two 30 inches polarizers are joined for 60 inches LCD. If the two joined 30 inches polarizer is used for 60 inches LCD, the boarder line between the two polarizers is shown. FIG. 4 illustrates the boarder line in 82 inches LCD panel.

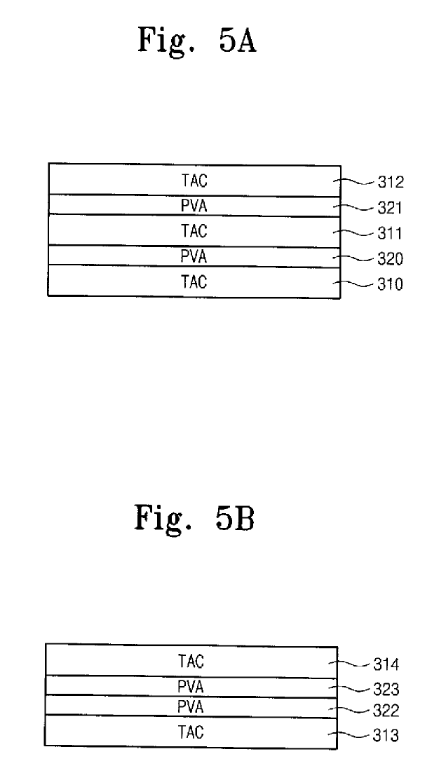

According to an exemplary embodiment of the present invention, a polarizer having two layers of polarizing elements 320 which is able to cover a large LCD is applied. In FIG. 5 (a), a polarizer includes a first, second and third support layers 310, 311, 312 and a first, second polarizing elements 320, 321. The first polarizing element 320 is disposed between the first support layer 310 and the second support layer 311 and the second polarizing element 321 is disposed between the second support layer 311 and the third support layer 312. At least one of the support layers 310, 311, 312 is a triacetyl cellulose film and the polarizing element is a polyvinyl alcohol layer.

According to an exemplary embodiment of the present invention shown in FIG. 5 (b), the first polarizing element 322 and the second polarizing element 323 are directly contacted each other without a support layer between them. Both the first polarizing element 322 and the second polarizing element 323 have 90% polarizing rate or less. At least one of the polarizing elements 322, 323 is a polyvinyl alcohol layer and at least one of the support layers 313, 314 is a triacetyl cellulose film.

For manufacturing a polarizer according to an exemplary embodiment of the present invention, a preparing step prepares an non-stretched polarizer having width and length, which includes at least two support layers and at least two polarizing elements, and a stretching step stretches the polarizer in the direction of length until the width of the polarizer after stretching is not less than half of the width of the polarizer before stretching. In an exemplary embodiment of the present invention, the width of the polarizer before stretching is about 3300 mm and the width of the polarizer after stretching is not less than 1870 mm. Furthermore, the diagonal length of the polarizer after stretching is not less than 60 inches.

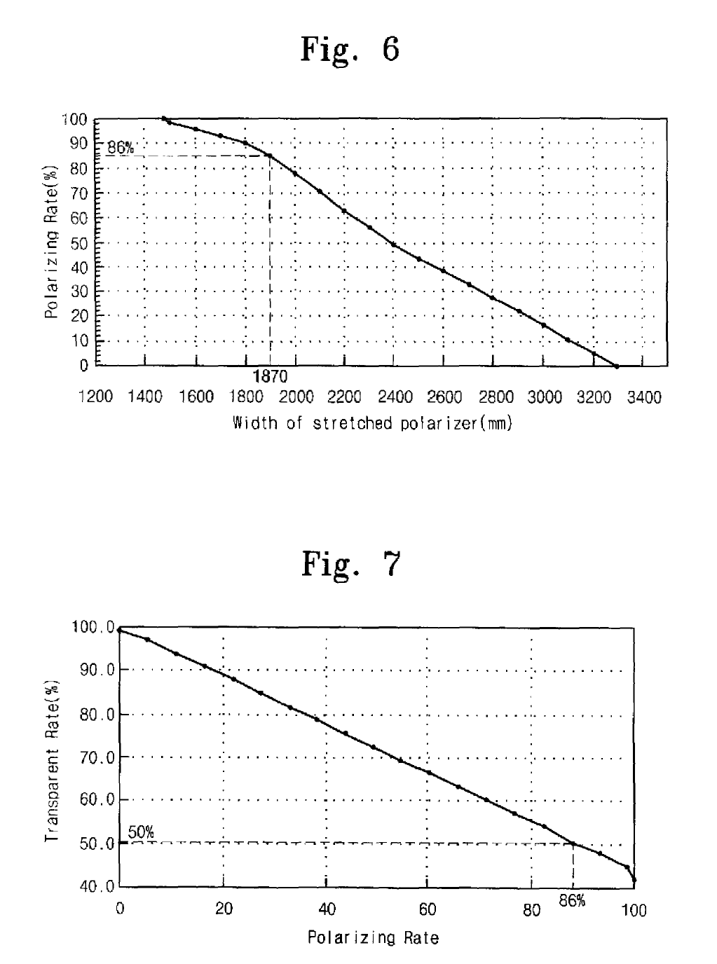

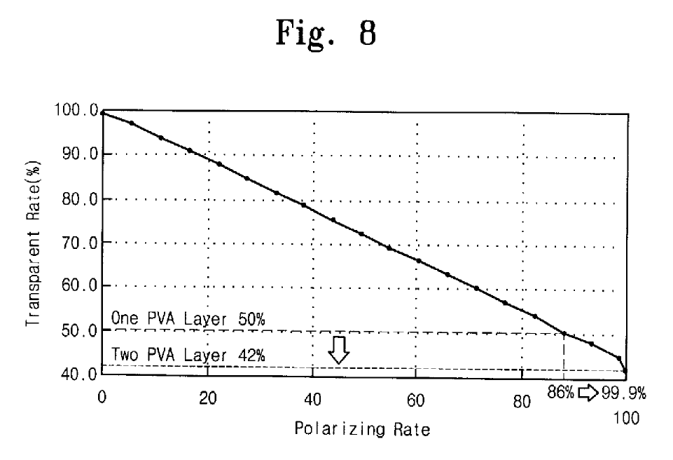

FIG. 6, FIG. 7 and FIG. 8 show the result of simulation. FIG. 6 illustrates a graph showing the relationship between polarizing rate and stretching rate. Depending on the stretching rate, the polarizing rate is increased. FIG. 6 shows that the width of non-stretched polarizer is reduced to 1470 mm from 3300 mm. When the non-stretched polarizer is stretched until the width of the non-stretched polarizer is 1470 mm, polarizing rate becomes almost 100%. However, if the non-stretched polarizer is stretched until the width of the non-stretched polarizer is 1870 mm to cover a large LCD panel, polarizing rate will be only 86%. This rate is not enough for the polarizer to be used in a LCD panel. FIG. 7 shows the relationship between polarizing rate and transparent rate. When polarizing rate is 86%, transparent rate will be 50%. Refer to FIG. 8, if the polarizer of present invention having two PVA layers is used, the polarizing rate will be almost 99.9% while transparent rate is reduced to 42% which is acceptable in a LCD panel.

Although the illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A polarizer comprising:
a first, second and third support layers;
a first polarizing element disposed between said first support layer and said second support layer; and
a second polarizing element disposed between said second support layer and said third support layer;
wherein both said first polarizing element and said second polarizing element have 90% polarizing rate or less.

2. The polarizer of claim 1, wherein at least one of said polarizing elements is a polyvinyl alcohol layer.

3. The polarizer of claim 1, wherein at least one of said support layers is a triacetyl cellulose film.

4. A polarizer comprising:
a pair of support layers; and
a first polarizing element and a second polarizing element which are directly contacted each other and disposed between said pair of support layers,
wherein both said first polarizing element and said second polarizing element have 90% polarizing rate or less.

5. The polarizer of claim 4, wherein at least one of said polarizing elements is a polyvinyl alcohol layer.

6. The polarizer of claim 4, wherein at least one of said support layers is a triacetyl cellulose film.

7. A display device comprising:
a light source to generate light;
a liquid crystal panel disposed in the path of the light source, and including a pair of substrates, an electrode formed on at least one of said substrates, a liquid crystal layer disposed between said pair of substrates;
a first polarizer disposed between said light source and said liquid crystal panel, and a second polarizer disposed on the top of said liquid crystal panel;
wherein at least one of said first and second polarizer comprises a first, second and third support layers, a first polarizing element disposed between said first support layer and said second support layer and a second polarizing element disposed between said second support layer and said third support layer; and
wherein both said first polarizing element and said second polarizing element have 90% polarizing rate or less.

8. The display device of claim 7, wherein at least one of said polarizing elements is a polyvinyl alcohol layer.

9. The display device of claim 7, wherein at least one of said support layers is a triacetyl cellulose film.

10. A display device comprising:
a light source to generate light;
a liquid crystal panel disposed in the path of the light source, the liquid crystal panel including a pair of substrates, an electrode formed on at least one of said substrates, a liquid crystal layer disposed between said pair of substrates;
a first polarizer disposed between said light source and said liquid crystal panel, and a second polarizer disposed on top side of said liquid crystal panel;
wherein at least one of said first and second polarizer comprises a pair of support layers and a first polarizing element and a second polarizing element which are directly contacted each other and disposed between said pair of support layers
wherein both said first polarizing element and said second polarizing element have 90% polarizing rate or less.

11. The display device of claim 10, wherein at least one of said polarizing elements is a polyvinyl alcohol layer.

12. The display device of claim 10, wherein at least one of said support layers is a triacetyl cellulose film.

13. A method of manufacturing a polarizer comprising:
a preparing step which prepares an non-stretched polarizer having a width and length, which comprises at least two support layers and at least two polarizing elements; and
a stretching step which stretches said polarizer in the direction of length until the width of said polarizer after stretching is not less than half of the width of said polarizer before stretching.

14. The method of claim 13, wherein the width of said polarizer before stretching is about 3300 mm and the width of said polarizer after stretching is not less than 1870 mm.

15. The method of claim 13, wherein the diagonal length of said polarizer after stretching is not less than 60 inches.

16. A method of manufacturing a polarizer comprising:
a preparing step which prepares an non-stretched polarizer having a width and length, which comprises a first, second and third support layers, a first polarizing element disposed between said first support layer and said second support layer and a second polarizing element disposed between said second support layer and said third support layer; and
a stretching step which stretches said polarizer in the direction of length until the width of said polarizer after stretching is not less than half of the width of said polarizer before stretching.

17. A method of claim 16, wherein both said first polarizing element and said second polarizing element have 90% polarizing rate or less after stretching.

18. A method of manufacturing a polarizer comprising:
a preparing step which prepares an non-stretched polarizer having a width and length, which comprises a pair of support layers and a first polarizing element and a second polarizing element which are directly contacted each other and disposed between said pair of support layers; and
a stretching step which stretches said polarizer in the direction of length until the width of said polarizer after stretching is not less than half of the width of said polarizer before stretching.

19. A method of claim 18, wherein both said first polarizing element and said second polarizing element have 90% polarizing rate or less after stretching.
